(19) United States
(12) Patent Application Publication
(10) Pub. No.: US 2013/0283066 A1
(43) Pub. Date: Oct. 24, 2013

(54) TEST SYSTEM FOR RESET AND POWER ON OR OFF OF COMPUTER

(71) Applicants: CHENG-FEI WENG, Shenzhen City (CN); JIE LI, Shenzhen City (CN); YU SHI, Shenzhen City (CN)

(72) Inventors: CHENG-FEI WENG, Shenzhen City (CN); JIE LI, Shenzhen City (CN); YU SHI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/564,764

(22) Filed: Aug. 2, 2012

(30) Foreign Application Priority Data
Apr. 20, 2012 (CN) 201210116947.X

(51) Int. Cl. G06F 1/26

(52) U.S. Cl. 713/300

(57) ABSTRACT

When a reset switch is pressed, a reset circuit controls a motherboard to reset and controls a controller to output a finish signal to a counting module. The counting module adds one and outputs the counting value to a display unit. When a power on/off switch is pressed, a power on/off circuit controls the motherboard to power on and controls the controller to output a finish signal to the counting module. The counting module adds one and outputs the counting value to the display unit. The power on/off circuit controls the motherboard to power off after one power on cycle is completed and controls the controller to output a finish signal to the counting module. The counting module adds one and outputs a counting value to the display unit.

### BACKGROUND

1. Technical Field

The present disclosure relates to a system for testing the reset and power on or off (on/off) functions of a computer.

2. Description of Related Art

In test, reset and power on/off of a computer need to be executed many times for avoiding computer errors. At present, the tests of the reset and power on/off of a computer are operated manually, thus, it will bring operation complexity and low efficiency.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments.

FIGS. 1 and 2 are block diagrams of a test system for reset and power on or off of a computer in accordance with an exemplary embodiment of the present disclosure.

### DETAILED DESCRIPTION

The disclosure, including the drawings, is illustrated by way of example and not by way of limitation. References to “an” or “one” embodiment in this disclosure are not necessarily to the same embodiment, and such references mean at least one.

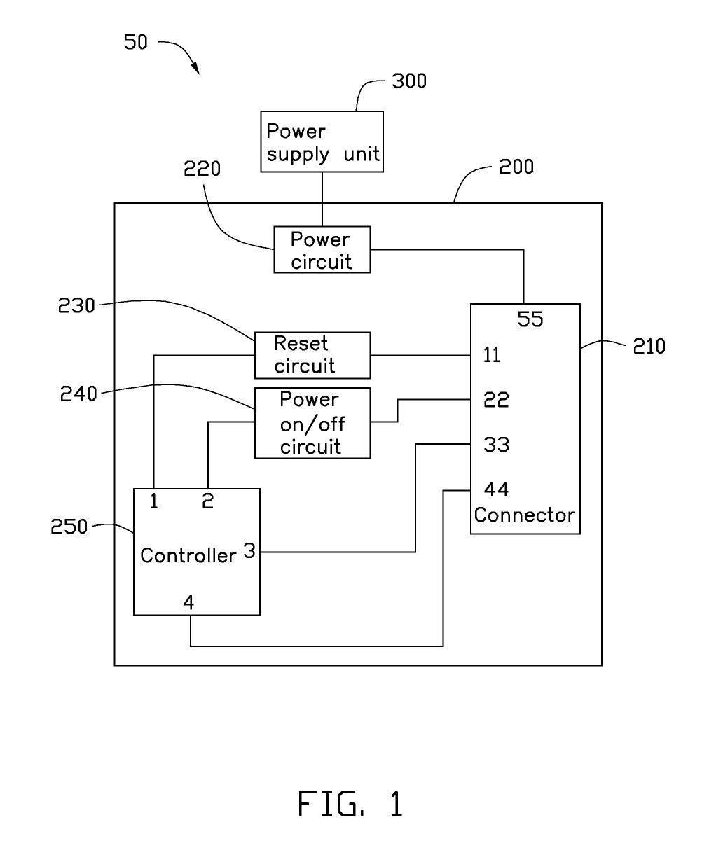

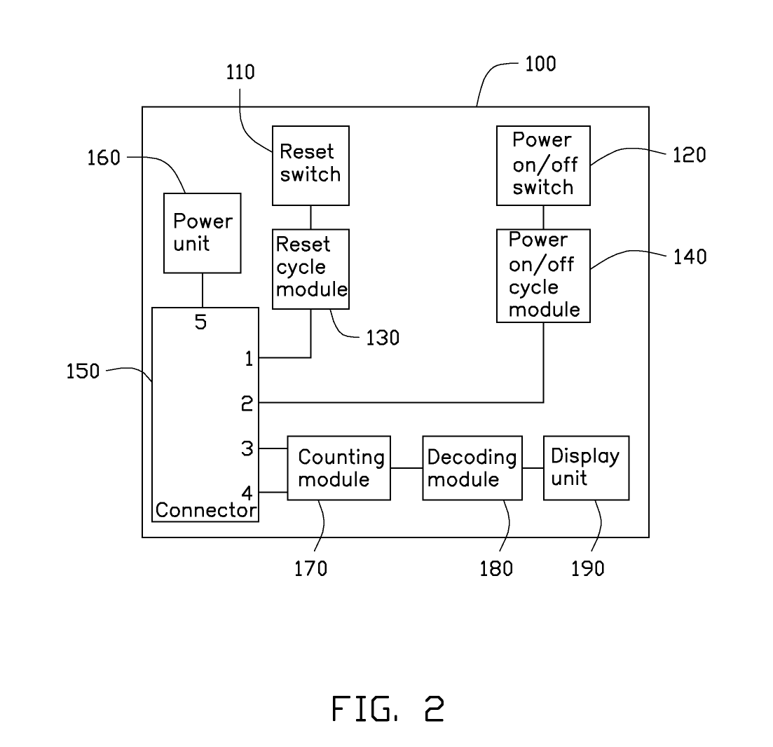

Referring to FIGS. 1 and 2, a test system 50 in accordance with an exemplary embodiment includes a test apparatus 100 and a motherboard 200 to be tested.

The test apparatus 100 includes a reset switch 110, a power on or off (on/off) switch 120, a reset cycle module 130, a power on/off cycle module 140, a connector 150, a power unit 160, a counting module 170, a decoding module 180, and a display unit 190. The reset switch 110, the power on/off switch 120, and the display unit 190 are exposed. The reset cycle module 130 includes a reset cycle (such as 1 minute) of the motherboard 200 and the number of reset of the motherboard 200 (such as 1000). The power on/off cycle module 140 includes the number of power on (such as 1000) of the motherboard 200, the number of power off (such as 1000) of the motherboard 200, a power on cycle (such as 70 seconds) of the motherboard 200, and a power off cycle (such as 70 seconds) of the motherboard 200.

The reset switch 110 is connected to a pin 1 of the connector 150 through the reset cycle module 130. The power on/off switch 120 is connected to a pin 2 of the connector 150 through the power on/off cycle module 140. The counting module 170 is connected to pins 3 and 4 of the connector 150 and also connected to the display unit 190 through the decoding module 180. The power unit 160 is connected to a pin 5 of the connector 150, to receive a voltage through the connector 150, convert the received voltage to a required voltage, and provide the required voltage to the test apparatus 100.

The motherboard 200 includes a connector 210, a power circuit 220, a reset circuit 230, a power on/off circuit 240, and a controller 250. In one embodiment, other elements of the motherboard 200 are well known. The reset circuit 230 is connected between a pin 11 of the connector 210 and a pin 1 of the controller 250. The power on/off circuit 240 is connected between a pin 22 of the connector 210 and a pin 2 of the controller 250. Pins 3 and 4 of the controller 250 are respectively connected to pins 33 and 44 of the connector 210. The power circuit 220 is connected to a power supply unit 300 and also connected to a pin 55 of the connector 210. The power circuit 220 receives a voltage from the power supply unit 300, converts the received voltage to a required voltage, provides the required voltage to the reset circuit 230, the power on/off circuit 240, and the controller 250, and also provides the required voltage to the power unit 160 of the test apparatus 100 through the connectors 150 and 210.

In use, the connector 150 is electrically connected to the connector 210, namely, the pins 1-5 of the connector 150 are correspondingly connected to the pins 11, 22, 33,44, and 55 of the connector 210. The power circuit 220 converts a voltage received from the power supply unit 300 to a required voltage and provides the requirement voltage to the power unit 160 through the connectors 150 and 210. When the reset switch 110 is pressed, the reset cycle module 130 receives a control signal, and outputs a low level signal to the reset circuit 230 through the pin 1 of the connector 150 and the pin 11 of the connector 210. The reset circuit 230 controls the motherboard 200 to reset, and controls the controller 250 to output a finish signal to the counting module 170 through the pin 33 of the connector 210 and the pin 3 of the connector 150 after the reset of the computer 200 is completed. The counting module 170 adds one and outputs the counting value to the decoding module 180 for decoding. The display unit 190 displays the counting value. After one reset cycle is completed, the reset cycle module 130 outputs a low level signal to the reset circuit 230 through the pin 1 of the connector 150 and the pin 11 of the connector 210 again. When the counting value reaches 1000, the number of the reset is completed.

When the power on/off switch 120 is pressed, the power on/off cycle module 140 receives a control signal and outputs a low level signal to the power on/off circuit 240 through the pin 2 of the connector 150 and the pin 22 of the connector 210. The power on/off circuit 240 controls the motherboard 200 to power on and controls the controller 250 to output a finish signal to the counting module 170 through the pin 44 of the connector 210 and the pin 4 of the connector 150. The counting module 170 adds one for powering on and outputs the counting value to the decoding module 180 for decoding. The display unit 190 displays the counting value for powering on. After one power on cycle is completed, the power on/off cycle module 140 outputs a low level signal again to the power on/off circuit 240. The power on/off circuit 240 controls the motherboard 200 to power off, and controls the controller 250 to output a finish signal to the counting module 170 through the pin 44 of the connector 210 and the pin 4 of the connector 150. The counting module 170 adds one for powering off and outputs the counting value to the decoding module 180 for decoding. The display unit 190 displays the counting value for powering off. After one power off cycle is completed, the power on/off cycle module 140 outputs a low level signal to the power on/off circuit 240 through the pin 2 of the connector 150 and the pin 22 of the connector 210 again. When the counting value for powering on/off reaches 1000, the number of the power on/off is completed.

The test system 50 can automatically control the motherboard 200 to reset and power on/off, and control the display unit 190 to display the counting value. Therefore, the test system 50 is operated simply and efficiently.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A test system for testing reset and power on or off (on/off) of a computer, the test system comprising:
a test apparatus comprising:
a first connector;
a decoding module;
a display unit;
a reset cycle module setting a reset cycle of the computer and the number of reset of the computer;
a power on/off cycle module setting a power on cycle of the computer, a power off cycle of the computer, the number of power on of the computer, and the number of power off of the computer;
a reset switch connected to a first pin of the first connector through the reset cycle module;
a power on/off switch connected to a second pin of the first connector through the power on/off cycle module;
a counting module connected to fourth and fifth pins of the first connector, and also connected to the display unit through the decoding module; and
a power unit connected to a third pin of the first connector, to convert a voltage received from the first connector to a first required voltage and provide the first required voltage to the test apparatus; and
a motherboard comprising:
a second connector connected to the first connector;
a reset circuit connected to a first pin of the second connector;
a power on/off circuit connected to a second pin of the second connector;
a power circuit connected to a power supply unit and a third pin of the second connector, to convert the voltage received from the power supply unit to a second required voltage and provide the second required voltage to the motherboard, and the power unit through the first and second connectors; and
a controller, wherein first and second pins of the controller are connected to the reset circuit and the power on/off circuit, third and fourth pins of the controller are connected to fourth and fifth pins of the second connector;
wherein when the reset switch is pressed, the reset cycle module receives a control signal and outputs a low level signal to the reset circuit through the first and second connectors, the reset circuit controls the motherboard to reset and controls the controller to output a finish signal to the counting module after the reset of the motherboard is completed, the counting module adds one for resetting and outputs the counting value to the display unit for displaying after the decoding module decodes; when the power on/off switch is pressed, the power on/off cycle module receives a control signal and outputs a low level signal to the power on/off circuit through the first and second connectors, the power on/off circuit controls the motherboard to power on and controls the controller to output a finish signal to the counting module after the power on of the motherboard is completed, the counting module adds one for powering on and outputs the counting value to the display unit for displaying after the decoding module decodes, the power on/off cycle module outputs a low level signal to the power on/off circuit again after one power on cycle is completed, the power on/off circuit controls the motherboard to power off and controls the controller to output a finish signal to the counting module after the power off of the motherboard is completed, the counting module adds one for powering off and outputs a counting value to the display unit for displaying after decoding module decodes.

2. The test system of claim 1, wherein the reset switch, the power on/off switch, and the display unit are exposed.
